(19) United States
(12) Patent Application Publication
(10) Pub. No.: US 2003/0227814 A1
(43) Pub. Date: Dec. 11, 2003

(54) Lightweight aggregate

(76) Inventors: Michael Priesnitz, Wyoming, MN (US); Thomas D. Hubbard, Chippewa Falls, MN (US); William B. Johnson, Monticello, MN (US)

Correspondence Address: Two Thousand Fahrenheit, Inc., c/o Sherburne EnviRock LLC, 11300 125th Avenue Southeast, Becker, MN, 55308, US

(21) Appl. No.: 10/166,163

(22) Filed: Jun. 10, 2002

(51) Int. Cl. C04B 38/00; B28C 5/00; B28C 7/04

(52) U.S. Cl. 366/2; 106/674; 106/712; 106/677; 106/679; 106/705; 106/710; 366/162.1; 366/8; 366/18

(57) ABSTRACT

Producing both colored and noncolored lightweight aggregates. The processes involve mixing a lightweight fine material such as ash with cement, and optionally pigment, then agglomerating the mixture, curing, and sizing the lightweight aggregate. Calcium stearate is added to the lightweight aggregate for reducing the moisture permeability of the lightweight aggregate end product. The colored and noncolored lightweight aggregate may be used in a variety of ways such as to provide a lightweight concrete mix with the same exterior and interior color, and for other asphalt pavement, geotechnical, horticulture, and specialty uses.

The present invention relates to methods and apparatuses for treating lightweight fine materials such as ash from power plant combustion processes to provide a stable lightweight aggregate. According to the invention, novel processes and apparatuses for making noncolored and colored lightweight aggregate are provided.

### BACKGROUND OF THE PRESENT INVENTION

There is a need to improve the environment by finding a better way to dispose of the voluminous combustion power plant ash waste by somehow making better economic use of ash in its different forms.

For example, fly ash (sometimes called “coal combustion fly ash”) is a dry waste product from coal burning operations such as coal fired boiler operations for the generation of power. The term “fly ash” is meant here to refer to the “light” ash which is the particulate material collected from off gases of a coal burning operation. Such coal ash or fly ash generally comprises a mixture of silica and alumina, with lesser amounts of other minerals. It is generated in very large amounts in this country. The volumes in which it is produced have generally well exceeded any uses to which it has been placed. Thus, it is often disposed of through waste disposal operations such as land filling. Fly ash can in some instances contain hazardous components, and thus sometimes requires special handling techniques for fly ash disposition.

Wet scrubber ash also can come from power plants and initially contains much more moisture than the dry fly ash. Wet ash is created at combustion power plants utilizing a wet scrubber for cleaning the flue gas prior to discharge into the atmosphere. The flue gas passes through a series of cascading water that removes particulates. The water is then discharged into ponds where the particulates disperse and settle down. Then the water is reclaimed from the ponds so it can be reused again in the wet scrubber process. The particulates, specifically the ash remains in the ponds.

Most of the lightweight aggregates used for making structural lightweight concrete on the market today are kiln expanded materials such as clay or shale which are fired in a kiln at approximately 1600 to 2000 degrees Fahrenheit. The lightweight aggregate product when split open reveals a black interior that is unsuitable for coloring the interior of the lightweight concrete product. Surface treatments, such as burnishing or splitting the face of the lightweight concrete product that is made from the current lightweight aggregate, expose the black interior of the lightweight aggregate and produce undesirable coloring results. Other current lightweight aggregates are made from pumice or from steel mill slag have similar unsuitable coloring results. Consequently, many of the lightweight concrete products made from the currently uncolorable lightweight aggregates require significant additional decorating time, materials, labor and money. For example, additional uncolorable lightweight aggregate decorating time, materials, labor and money must currently be spent on exterior painting, and interior dry walling and painting. Inventing a lightweight aggregate made of waste materials such as ash at ambient temperature that is colorable for producing colorable lightweight concrete products would provide significant environmental and economic benefits.

The lightweight aggregate and lightweight concrete commodities market has been at times crowded with sellers and slow with buyers which creates a need for new products at the high end niches for value added products.

Currently a significant disadvantage to current lightweight aggregate is that it has high moisture permeability. Consequently, the lightweight aggregate and other products made from the lightweight aggregate can not be used outdoors in northern climates such as on building exteriors without expensive sealing. For example, a building in Minnesota having an exterior made of split-faced lightweight concrete units may require three coats of paint: a sealer and two additional coats of paint to seal the exterior. It would be a significant advantage to current lightweight aggregate to reduce its moisture permeability.

### SUMMARY OF THE INVENTION

One object of the invention is to provide a colored lightweight aggregate having the same uniformly colored interior and exterior without a discolored black interior.

Another object of the invention is to provide both colored and noncolored lightweight aggregate with reduced moisture permeability.

Most of the lightweight aggregates produced today require the use of a kiln fueled by expensive gas or air polluting coal in the manufacturing process. The processes of the present invention eliminate the use of a kiln and therefore eliminate air polluting kiln emissions and provide lower production costs.

Both wet and dry lightweight fine material continuous processes for making noncolored lightweight aggregate have been improved by the present invention. The curing step has been improved in at least four ways. The splitting step has been eliminated. Previously the splitting step required an apparatus that would divert some portion of the cured pellets that had been exposed to carbon dioxide for over 24 hours away from proceeding further along towards the end of the process. The diverted portion of the cured pellets was returned to the curing pile 90 for mixing with the new additional green pellets to inhibit the pellets from sticking together into clumps. Now the splitting step can be omitted while retaining the function of inhibiting clumps.

A second improvement to the curing step is the significant savings in time spent exposing the pellets to carbon dioxide. Previously, green pellets were cured by piling the pellets in a stationary bin with a hose slowly leaking carbon dioxide into the bin pile onto the pellets over the duration of a 12-24 hour period. Now the pellet exposure to carbon dioxide is reduced to between 5 and 10 minutes.

A third curing step improvement is the reduction in time spent cooling off pellets in a curing room from previously a 12-24 hour holding period to now an eight-hour period.

A fourth improvement to the curing step is the elimination of the shell-breaking step. Previously pellets exposed to carbon dioxide on the outside of the curing pile 90 would tend to bond together creating a hardening shell on the outside of the pile 90. The shell would have to be broken up at that time. Now, a rotating drum during the carbon dioxide exposing step eliminates the need for a separate shell-breaking step here while retaining the function.

The mixing step has been improved also. Previously hydrogen peroxide was introduced with the raw material during the mixing step. Now the problem of clumping during the mixing stage has been eliminated. Previously there were separate steps for introducing hydrogen peroxide to the raw material mixture and introducing water spray to the mixture. Now both steps have been combined into one step but with the same functions retained.

The additional capacity to make gradations between coarse and fine lightweight aggregate has been added to the process. Previously only coarse aggregate could be made. Now both coarse and fine lightweight aggregates can be made into various gradations and can be sold at each grade. In addition to the numerous improvements to the noncolored process for making lightweight aggregate, a new process for making colored lightweight aggregate is provided.

According to the present invention, four processes for preparing noncolored and colored lightweight aggregate from wet or dry lightweight fine material are provided. The processes for providing lightweight aggregate from lightweight fine material include the step of mixing a raw material mixture of cement and lightweight fine material. That lightweight fine material may include various materials including both dry and wet ashes such as wet scrubber ash and dry fly ash. The second step of the process is agglomerating the mixture from the first mixing step. Simultaneously adding hydrogen peroxide and water to the raw material mixture during the agglomerating step can also be included in the process. The last step is curing the agglomeration from the agglomerating step. That curing the agglomeration step may include adding carbon dioxide to the agglomeration and may include adding carbon dioxide to a rotating container.

The present invention also includes a concrete mix comprising cement and aggregate produced by the process for producing lightweight aggregate from fine material. According to the present invention, another process for preparing colored lightweight aggregate from lightweight fine material is provided. The first step involves mixing a raw material mixture including cement and lightweight fine material. A second step of the process involves homogeneously mixing pigment with the raw material mixture from the mixing step. The third step is agglomerating the raw material mixture from the previous step. The last step is curing the agglomeration from the previous step in the presence of carbon dioxide.

The present invention also provides an apparatus for making colored lightweight aggregate from lightweight fine materials. The apparatus comprises a mixer for mixing raw materials of ash and cement. The apparatus also includes a homogeneous mixer for mixing pigment with the raw materials. Third, the apparatus includes an agglomeration for agglomerating the mixture from the homogeneous mixer. Finally, the apparatus includes a carbon dioxide curer connected to the agglomerator for curing the agglomeration with carbon dioxide.

The present invention also provides an apparatus for making lightweight aggregate from lightweight fine materials including a mixer, an agglomerator, and a carbon dioxide curer. The agglomerator includes a sprayer connected to a hydrogen peroxide source in liquid communication with the raw material and the agglomerator. The carbon dioxide curer includes a rotating container for curing the agglomeration in the presence of carbon dioxide.

The present invention provides a lightweight aggregate article of manufacture from lightweight fine materials including a cement element and an ash element agglomerated to the cement element for making lightweight concrete. The present invention also provides a lightweight aggregate article of manufacture further comprising a pigment element agglomerated to the cement element and the ash element for making colored lightweight aggregate.

In the processes, several additional optional embodiments of the present invention involve the introduction of calcium stearate into the lightweight aggregate for reducing the absorption of the lightweight aggregate product. The process for producing colored lightweight aggregate in the step of (b) homogeneously mixing a pigment with the raw material mixture from the step of mixing (a) comprises homogeneously mixing calcium stearate with the pigment with the raw material mixture. In the process for producing colored lightweight aggregate after the step of agglomerating the material mixture (c), add calcium stearate to the colored lightweight aggregate. In the process for producing colored lightweight aggregate during the step of curing the agglomeration (d), add calcium stearate to the colored lightweight aggregate. In the process for producing lightweight aggregate the step of mixing a raw material mixture including cement and a lightweight fine material (a) includes calcium stearate in the raw material mixture. In the process for producing lightweight aggregate, further comprising after the step of agglomerating the material mixture (c), add calcium stearate to the lightweight aggregate. In the process for producing lightweight aggregate during the step of curing the mixture (d), add calcium stearate to the lightweight aggregate.

Also in the compositions and apparatuses, several additional optional embodiments of the present invention involve the introduction of calcium stearate into the lightweight aggregate for reducing the absorption of the lightweight aggregate product. A concrete mix may further comprise calcium stearate. The colored lightweight aggregate may further comprise calcium stearate. The apparatus for making colored lightweight aggregate further comprises a reroll ring connected to the agglomerator for coating the colored lightweight aggregate with calcium stearate. The apparatus for making colored lightweight aggregate further comprises a supply source of calcium stearate in communication with the carbon dioxide curer for coating the colored lightweight aggregate with calcium stearate.

These and other benefits of the present invention will become apparent from the following detailed description taken in conjunction with the accompanying drawings, where like reference numerals designate like elements throughout the views.

### BRIEF DESCRIPTION OF THE DRAWINGS

FIGS. 1A-1B are symbolic and schematic views of a method of making colored lightweight aggregate in a continuous plant setting according to one embodiment of the present invention.

### DETAILED DESCRIPTION OF THE INVENTION

As used in this description and in the appended claims, the following term, “lightweight” when used with the term lightweight aggregate means a material having a density of less than 70 lbs per cubic foot. In contrast to lightweight aggregate, a normal weight aggregate such as sand and gravel each has a greater density, closer to about 110 lbs per cubic foot and 105 lbs per cubic foot respectively. As used in this description and in the appended claims, the following term, “fine” when used with lightweight material or lightweight aggregate means a material having a size that can pass through a #8 sieve with a screen square opening of ⅜th inch. Further, “coarse” when used with lightweight material or lightweight aggregate means a material having a size that can not pass through and is retained by a #8 sieve with a screen square opening of ⅜th inch. The terms lightweight concrete or concrete mix mean concrete made from a lightweight aggregate.

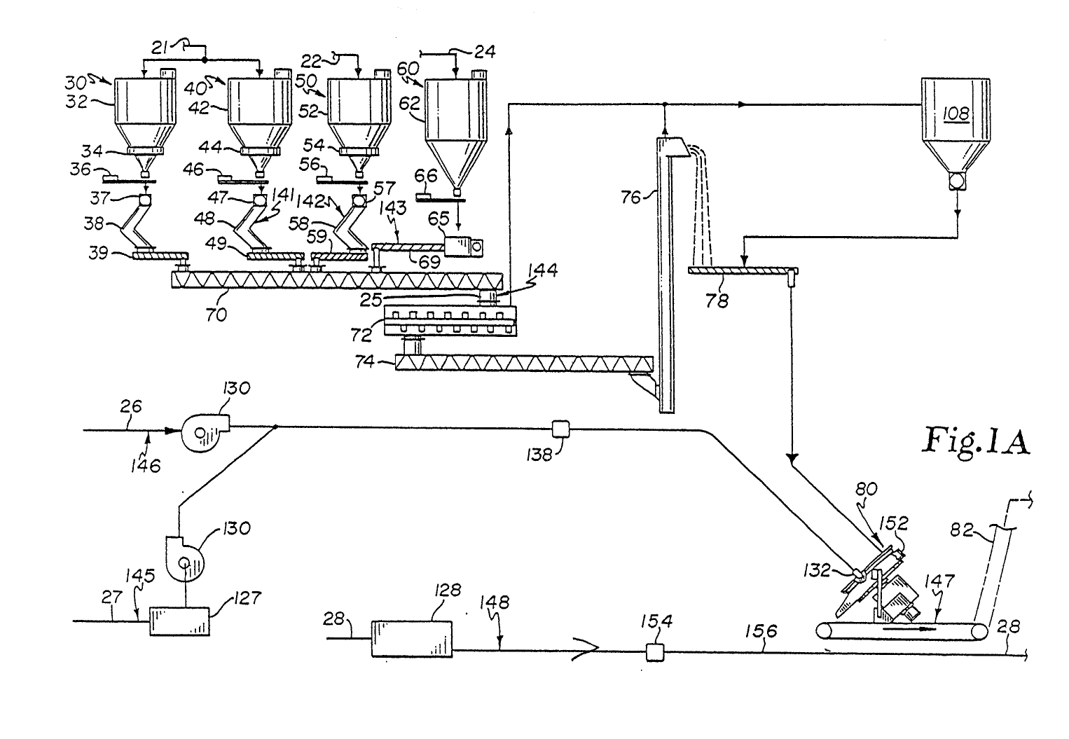

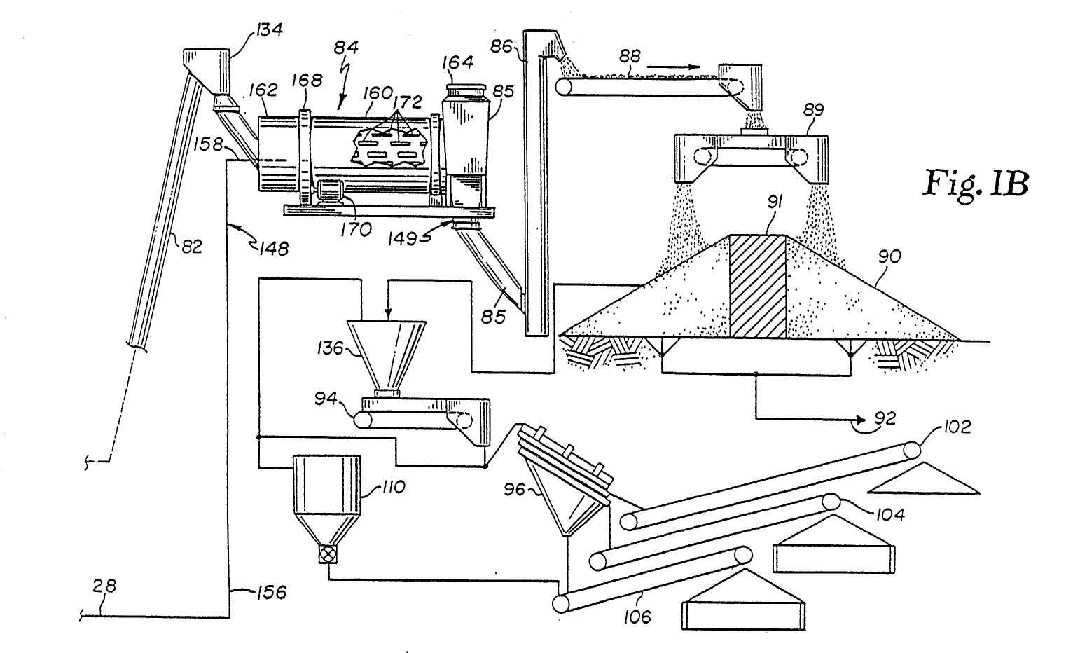

An apparatus for making lightweight aggregate from a lightweight fine material comprises a mixer for mixing cement and a lightweight fine material, an agglomerator connected to the mixer for agglomerating the raw material mixture, and a carbon dioxide curer connected to the agglomerator where the curer includes a rotating container for curing the agglomeration in the presence of carbon dioxide. FIGS. 1A-1B show schematic views of the apparatus used in a method of making colored lightweight aggregate in a continuous plant setting according to one embodiment of the present invention. More specifically, a first ash silo assembly 30 and a second ash silo assembly 40 is used for both receiving ash 21 and for dispensing ash 21.

The first ash silo assembly 30 includes an ash silo 32 having a five hundred ton capacity with preferably in a funnel shape. Near the bottom of the ash silo 32 is the bin discharger 34 having a generally rectangular shape disposed parallel with the top of the ash silo 32. The slide gate 36 is placed between the bottom of the ash silo 32 and the top of a rotary valve 37. An impact weigher 38 is connected between the rotary valve 37 and the screw conveyor 39. The other end of the screw conveyor 39 discharges ash 21 into one end of the first mixing screw 70.

The second ash silo assembly 40 has the same configuration. The ash silo 42 stores and funnels ash 21. A slide gate 46 is disposed between the ash silo 42 and the rotary valve 47. The impact weigher 48 is connected at one end to the rotary valve 47 at the other end to the screw conveyor 49. The other end of the screw conveyor 49 is connected with the first mixing screw 70.

The cement silo assembly 50 comprises a cement silo 52 with cement bin discharger 54. A cement slide gate 56 is disposed between the cement silo 52 and the cement rotary valve 57. The cement impact weigher 58 is connected at one end to the cement rotary valve 57 and at the other end to the cement screw conveyor 59. The other end of the cement screw conveyor 59 connects to the first mixing screw 70.

The pigment silo assembly 60 comprises a pigment storage silo 62 with a pigment slide gate 66 disposed below the pigment silo 62. A pigment volumetric feeder 65 is placed below the slide gate 66 and is connected to the pigment screw conveyor 69. The other end of the pigment screw conveyor 69 is connected to the first mixing screw 70.

Several additional optional embodiments of the present invention involve the introduction of calcium stearate 25 into the lightweight aggregate for reducing the absorption of the lightweight aggregate product. The apparatus for making colored lightweight aggregate further comprises a reroll ring 152 connected to the agglomerator in the form of the pan pelletizer 80 for coating the colored lightweight aggregate with calcium stearate 25. The apparatus for making colored lightweight aggregate further comprises a supply source of calcium stearate 25 in communication with the carbon dioxide curer for coating the colored lightweight aggregate with calcium stearate 25. In another preferred embodiment, the calcium stearate 25 is introduced to the lightweight aggregate at the upstream end of the carbon dioxide curing drum 84. Thus the calcium stearate 25 is introduced to the lightweight aggregate at one or more locations at the paddle mixer 72, the reroll ring 152, or the upstream end of the carbon dioxide curing drum 84.

The material may be agglomerated with equipment such as pan pelletizers, drum granulators, pin mixers, and pug mixers. Preferably, a pan pelletizer 80 may be used such as the FEECO Pelletizing Disc available from FEECO INTERNATIONAL of Green Bay, Wis. Other pelletizer manufacturers include FABTECH of Wyandotte, Mich.; Allis Material System, Waukesha, Wis.; HMC, Mars, Pa.; and Teledyne-Readco, York, Pa. Other agglomerators include but are not limited to equipment for coating, balling and pug mixer granulating functions. The pan pelletizer 80 may be constructed of heavy, welded, reinforced carbon steel plate with the inner pan (or disc) bottom lined with expanded metal to reduce abrasive wear. The pan angle is adjusted horizontally from 40 degrees to 60 degrees by a hand-wheel operated jacking screw. The base and the plow support members provide rigidity while simultaneously allowing rapid pan angle adjustment without the need for a separate plow adjustment. Individually mounted vane type plows that extend a predetermined length from the center to the periphery of the pan are used for controlling and maintaining the aggregate layer oner the entire surface of the pan. The pivot base of the pan pelletizer 80 is a rotatable member mounted on heavy-duty anti-friction bearings. The pan is directly mounted on the output shaft of a parallel shaft reducer.

A reroll ring 152 may be mounted onto the periphery of the pan pelletizer 80 for introducing calcium stearate 25 to the pellets. The reroll ring 152 is a piece of angle material that is rolled to fit the outside diameter of the pan pelletizer 80 for use in coating the colored lightweight aggregate with calcium stearate 25. The reroll ring 152 is fixed to the exterior of the pan pelletizer 80. The lip of the reroll ring 152 extends perpendicularly away from and relative to the base of the pan pelletizer 80 a distance farther than the lip of the pan pelletizer 80. The snowballing pellets cascade down from the sloped pan pelletizer 80 into the calcium stearate 25 stored on the reroll ring 152 for coating the pellets with the calcium stearate 25

The paddle mixer 72 is a horizontal mixing and conditioning device. The paddle mixer 72 may have a horizontal U-type trough with dual shafts and paddles extending the length of the trough. The action of the pitched paddles moves the raw material from the bottom of the trough up each side and forces the raw material back down between the shafts. The paddle mixer 72 is connected at one end to the mixing screw 70 and at the other end is connected to a second mixing screw 74. The other end of the second mixing screw 74 is connected to the bottom end of a feed elevator 76. The top end of the feed elevator 76 discharges the mixture into a screw conveyor 78. The other end of the screw conveyor 78 is connected to the 16-foot pan pelletizer 80.

Directed towards the interior of the pan pelletizer 80 is at least one spray nozzle 132. The number of spray nozzles 132 is a function of the radius of the pan pelletizer 80 such that all of the dry mixture is evenly exposed to the spray in the pan pelletizer 80. From a water source such as a water tap, water 26 is directed through a metering pump 130 and a flow meter 138 to a spray nozzle 132 and then onto the material in the pan pelletizer 80. Hydrogen peroxide 27 is directed from a hydrogen peroxide tank 127 through a metering pump 130 and a flow meter 138 to a spray nozzle 132 onto the pan pelletizer 80.

A carbon dioxide curing drum 84 apparatus for the curing stage is connected to the other end of the inclined belt conveyor 82 by way of the drum feed hopper 134. The source the carbon dioxide 28 is a carbon dioxide storage tank 128 that is connected to a carbon dioxide pressure regulator valve 154 and then to the carbon dioxide curing drum 84. Another end of the carbon dioxide curing drum 84 is connected to a load-out conveyor 88 by means of a product elevator 86 and a conveyer 85. A shuttle conveyor 89 is disposed below the load-out conveyor 88.

The carbon dioxide curing drum 84 comprises a rotating drum 160 supported by a fixed upstream breaching 162 and a downstream breaching 164 at each of its ends. A carbon dioxide supply line 156 is connected to the fixed upstream breaching 162 by means of a sparger 158. A chain 168 connects on the outside of the rotating drum 160 to a motor 170. The interior of the rotating drum 160 has a plurality of mixing flights. The downstream breaching 164 is connected to the conveyer 85 for the exit of pellets from the carbon dioxide curing drum 84.

The carbon dioxide curing drum 84 is connected to the breechings at both ends, namely at both the upstream end and at the downstream end of the carbon dioxide curing drum 84. The body of the carbon dioxide curing drum 84 rotates and is driven by a rotary drive having a chain around the exterior of the body near the upstream end of the carbon dioxide curing drum 84 and connected to a motor. Mounted inside the body of the carbon dioxide curing drum 84 are at least four mixing flights 172. Moreover the mixing flights 172 represented symbolically in FIG. 1B is known in the art. In one invention embodiment of the mixing flights 172, the structure of the mixing flights 172 includes mixing flights 172 spaced 90 degrees from each other for folding the pellets to maximize the exposure of the pellets to carbon dioxide gas 28. The lengths of the mixing flights 172 relative to the body of the carbon dioxide curing drum 84 can vary. Running over the carbon dioxide curing drum 84 and dropping down into the upstream breeching is at least one conduit called a sparger 158 for directing the carbon dioxide into the carbon dioxide curing drum 84 at the fixed upstream breeching 162 and extends into the body of the curing drum 84 a length of about a third to a half of the length of the carbon dioxide curing drum 84. The body of the carbon dioxide curing drum 84 has a slight slope that declines horizontally ten degrees or less from the upstream end to the downstream end of the carbon dioxide curing drum 84 to urge the material forward.

FIG. 1B represents in symbolic form and schematic view one embodiment of the present invention. A shuttle conveyor 89 drops pellets down onto the energy dissipating plates 91 that are fixed together into one device to break the fall of the pellets. In that symbolic form in FIG. 1B, the shuttle conveyor 89 drops pellets from either side, but not from both sides of the shuttle conveyor 89. Those energy dissipating plates 91 are preferably contained within at least one bin having vertical side walls (not shown). The energy dissipating plates 91 are represented symbolically in FIG. 1B and are a multiple plate configuration of the type known in the art. The energy dissipating plates 91 include two vertical sides extending substantially as high as the bin walls and disposed perpendicularly to the bin floor at the bin center. The energy dissipating plates 91 are vertically spaced and slope downwardly towards the opposing vertical side wall so as to divert the cured pellets into a pile 90 as shown in FIG. 1B.

A particulate removal system or device, such as a bag house precipitator or separator for removal of particulates is used in the mixing area and the sizing area. For example, in the FIG. 1A, dusting gases are shown to billow from areas such as the paddle mixer 72 and the feed elevator 76 and be directed into a first bag house 108 for removal of particulates. From the first bag house 108 particulates are collected and directed to the pan pelletizer 80 for agglomeration. In the sizing area, a second bag house 110 collects particulate matter and directs it to the fine product belt 106 for filing in the fine product area.

It is anticipated that processes according to the present invention will be conducted on a very large scale, to process large volumes of lightweight fine material such as ash 21. In part, this will be driven by both the present need for disposition of large volumes of such materials, and the high utility of the resulting lightweight aggregate product. For the purposes of this application, the term “lightweight” when used with the term lightweight fine material means a fine material having a density of less than 70 lbs per cubic foot. The ash element, such as ash 21, can be a variety of ash types and blends of ash for the purposes of this invention. The ash 21 is preferably coal ash such as fly ash, stack scrubber solids or bottom ash, although the invention will also work using refuse derived fuel (RDF) ash. As for acceptable moisture content, the ash 21 can be a dry ash such as fly ash or a wet ash such as wet scrubber ash or bottom ash. Consequently, the dry lightweight fine material can be fly ash and the wet lightweight fine material can include wet scrubber ash or bottom ash.

Fly ash is produced in very large volumes in this country, and it is a useful material for the ash component. In some compositions, the ash component may comprise 100% fly ash, 100% sanitary waste ash or mixtures thereof. It is preferred, for typical use as a lightweight aggregate and concrete and the like, that the material have sufficient strength to withstand mixing, pouring, et cetera.

Typical fly ash materials obtained by separating particulate material from off gases of combustion process, for example with electrostatic precipitators, may be used in processes according to the present invention without further preparation or processing. Generally, such materials include a substantial content of alumina, silica, and in some instances, hematite. The following list of fly ash materials and sources is indicative of the materials that may be used in processes according to the present invention.

Xcel Energy Co. (XCEL fly ash), Becker, Minn.

Minnesota Power Co. (MP fly ash), Cohasset, Minn.

Pulliam Power Co. fly ash (Pulliam), Green Bay, Wis., (no analysis available).

Appleton Paper Ash (boiler fly ash), Combined Locks, Wis., analysis (% by weight): Fe—2.20%; SiO.sub.2—38.40%; Al.sub.2 O.sub.3—23.90%; CaO—2.97%; MgO—0.79%; S—0.60%; C—23.20%; LOI—26.72%; H.sub.2 O—1.9%.

Xcel Energy Co. (Minneapolis XCEL fly ash), Minneapolis, St. Paul, Minn.

The MP and XCEL fly ash are believed to be of similar composition to Pulliam fly ash.

Potlatch ash from Potlatch Paper Co. of Cloquet, Minn. (Potlatch ash is a fly ash produced from incineration of coal and wet sludge); analysis: (% by weight—dry basis) Fe—0.9%; SiO.sub.2—11.65%; Al.sub.2 O.sub.3—9.33%; CaO—17.07%; MgO—0.51%; TiO.sub.2—3.32%; H.sub.2 O—0.415, Na.sub.2 O—0.19%; P.sub.2 O.sub.5—0.21%; MnO—0.02%; S—0.04%; LOI—56.62%; moisture content 53.9%.

Typically bottom ash materials are obtained from bottom of the coal or coke combustion plant.

In general, processes according to the present invention are for making both colored or uncolored lightweight aggregate from ash and include the following steps: mixing raw materials, agglomerating, curing, sorting, and storing. Generally, inside the plant is where the mixing, the agglomerating, and curing occurs and outdoors is where the sorting and storing occurs. Inside the plant at the mixing stage, a closed system is employed along with an aspirator to collect dust into a first bag house 108 for subsequent transport to the agglomerating step 14. As illustrated in FIGS. 1A-1B, schematic views of a method of making colored lightweight aggregate in a continuous plant setting according to one embodiment of the present invention begin with supplying ash 21, cement 22, and pigment 24.

In processes for making colored lightweight aggregate by the present invention, the stage of mixing the raw materials comprises two steps: first, rough mixing the raw materials and second, homogeneous mixing the raw materials with the pigment. In processes for making noncolored lightweight aggregate by the present invention, the stage of mixing the raw materials only requires the step of rough mixing the raw materials and does not require homogeneous mixing because the pigment is omitted.

Any of a variety of means may be used to provide initial mixing of the ash with the cement and optionally the pigment to form a raw material mixture. In general, for a continuous feed system, it is foreseen that each component will be metered from its storage bin, continuously, into a continuous feed mixer such as the first mixing screw 70.

Ash 21 stored in a first ash silo 32 is subjected to vibrations from a bin discharger 34, 44. The ash 21 flows past an open slide gate 36, 46 and moves through a rotary valve 37, 47 into an impact weigher 38, 48 for measuring. The ash 21 is transferred by a screw conveyer 39, 49 into the first mixing screw 70 for mixing with the cement 22 and optionally for mixing with the pigment 24.

Cement 22 held in a cement silo 52 is subjected to vibrations by the cement bin discharger 54 near the bottom of the cement silo 52 to counteract clumping when exiting at the narrowed base of the cement silo 52. Cement 22 flows out the bottom of the cement silo 52 past the cement slide gate 56 and through a cement rotary valve 57 for measuring by a cement impact weigher 58. The cement 22 is conveyed from the cement impact weigher 58 to the first mixing screw 70 by means of a cement screw conveyor 59.

When making lightweight colored aggregate, a source of supply of a color additive material such as a pigment 24 is available from a variety of vendors such as Dynamic Color Solutions, Inc. of Milwaukee, Wis. 53207. The amount of pigment 24 depends in part on the shade of desired color and the volume of cementious material involved. The delivery mechanism for the pigment 24 is a pigment silo assembly 60 that includes a pigment silo 62 for receiving pigment from 4,000 lb supersack bags. The pigment 24 flows out the bottom of the pigment silo 62 past an open pigment slide gate 66 into a pigment volumetric feeder 65 for measuring. The pigment 24 is then transported from the pigment volumetric feeder 65 by a pigment screw conveyor 69 into the first mixing screw 70. The type of mixing of the ash 21, cement 22 and pigment 24 in the first mixing screw 70 is a rough or casual mixing.

After the step of initial rough mixing, an additional homogeneous mixing step is used for the colored lightweight aggregate process but is unnecessary for the noncolored lightweight aggregate process. While various devices may be used for the homogenous mixing to thoroughly mix the pigment with the ash 21 and cement 22, in general it is foreseen that the process will be conducted on a continuous flow through basis. An example of equipment that is particularly well adapted for this use is a paddle mixer 72. The homogenous mixing is an important part of making the colored lightweight aggregate process because the pigment 24 needs to be evenly and thoroughly distributed throughout the entire mixture.

The components during the rough mixing of raw materials for the standard process of making lightweight aggregate should be mixed according to the following theoretical weight ratio. The theoretical weight ratio based on a theoretical dry ash to cement weight ratio preferably is within the range of 10/1 to 4/1 or more preferably about 10/1 to 6/1 and most preferably about 10/1. In general, the ash and cement will have essentially a dry, up to 1% moisture content.

In general, the stage of rough mixing will be conducted such that the materials are well mixed but not blended. In a first mixing screw 70, for example, the materials are forced through a trough in which they encounter rotating mixing blades that mix and direct the material on through the first mixing screw 70. Such a system is an effective way of mixing the dry materials. The consistency of the material as it passes through the first mixing screw 70 is generally light, somewhat like flour; the mixture containing, if it is only fly ash, about less than 1% moisture by weight.

A rough mixing step can be conducted at ambience and so the temperature at which this step is conducted will vary depending upon the climate and weather conditions. It is foreseen that if the temperature is significantly below about 0□ C, water and hydrogen peroxide used during the agglomeration stage may freeze. Under such situations, heat may be applied to appropriate areas to inhibit freezing.

It is foreseen that in many applications, the lightweight fine material can be entirely one type of ash 21 or the ash element can comprise a blend of ash materials obtained from various sources. In such applications, the ash element 21 may be individually fed from feed bins, using appropriate metering devices. The ash blends are preferably selected so that consistently high quality aggregates are produced. The specific ratio of ash blends may be determined from the individual characteristics of each ash source and may then be combined to achieve the final amount of calcium oxide (spent lime), silica, magnesium, calcium sulfate (gypsum), and alumina presence desired for the particular lightweight aggregate product subsequent use.

During the conduct of the homogeneous mixing, using the paddle mixer 72, the material is fed into a set of spinning paddles and is subjected to high shear. The homogenous mixing, if done as described, is preferably conducted such that the material exiting the process has a moisture content of up to about 1% but does not have a moisture content much greater than about ten percent by weight, or the material will not pelletize well. Also, it need not be conducted such that the material moisture content is lowered to less than ten percent by weight, or energy will be wasted because water spray is added during the agglomerating step. The material exiting the mixing process will generally have a consistency of a dry material such as flour. Such material can be readily pelletized using conventional techniques.

After mixing, the blended material is agglomerated. A variety of conventional techniques may be used for agglomerating during operation of this process on a continuous flow through basis. For example, a pan pelletizer 80 may be used such as the FEECO Pelletizing Disc available from FEECO INTERNATIONAL of Green Bay, Wis. Other pelletizer manufacturers include FABTECH of Wyandotte, Mich.; Allis Material System, Waukesha, Wis.; HMC, Mars, Pa.; and Teledyne-Readco, York, Pa. Other agglomerators include but are not limited to equipment for coating, balling and pug mixer granulating functions.

Agglomeration is a technique of upgrading the size of fine particles to enable more complete utilization of the material and to increase the ease of material handling. Agglomeration is accomplished by mixing lightweight fine material with a spray of liquid and possibly a binder material. The particular equipment chosen for agglomerating depends in part on the size, hardness, percent of moisture and other characteristics of the raw supply material that will help develop a quality end product. The material to be agglomerated may be accomplished with equipment such as pan pelletizers, drum granulators, pin mixers, and pug mixers.

In a preferred embodiment of the present invention, a continuous lightweight fine dry material process for making colored lightweight aggregate utilizes an agglomerator such as a disc or pan pelletizer 80. During pelletizing, the lightweight fine raw material is continually added to the pan and wetted by a fine water spray. The rotating action of the pan forms seed type particles from the moistened materials. The seed particles roll into larger particles until they discharge from the pan. The pelletizing of blended mixture into pellets step comprises two sub-steps; exposing the material to an ultraviolet light source, and spraying a fine mist of hydrogen peroxide and water.

The blended material in the pelletizer is exposed to an ultraviolet light source such as sunlight or a fluorescent light source for preferably a second or more. In a preferred embodiment of the invention, the mixed materials are exposed to ultraviolet light (not shown) in a feeder (not shown) used for directing the mixed materials into an agglomerator such as a pan pelletizer 80 for agglomerating. An example of the ultraviolet light source that could be used in the exposing step is a grow lamp fluorescent light source of small size such as 18 inches in length, with as little as 15 watts, for a duration of one or more seconds. Sunlight, if available, could also be used as another ultraviolet light source.

The step of spraying a fine mist of hydrogen peroxide and spraying water is preferably done simultaneously at the pan pelletizer 80. The hydrogen peroxide 27 can be mixed in a water tank such that all the water 26 needed to make the lightweight aggregate will be used to dilute the hydrogen peroxide, or more preferably the hydrogen peroxide 27 can be fed into the water line via a metering pump 130. It is preferred that the spray be directed to the upper right quadrant of the disc pelletizer 80 near where the blended mixture input falls onto the pan. Preferably the hydrogen peroxide 27 is in the range of a 35% to 50% concentrate mix and is available from many sources such as Hawkins Chemical of Minneapolis, Minn.

In general, agglomeration will be conducted to generate “green pellets” or “wet pellets” depending upon the particular size or grade of the product desired. For example, typically and preferably the green pellets are made within the size range of about ⅜th inch to 100 sieve if the aggregate is made for producing lightweight concrete products, or a maximum ¾ inch if the aggregate is made for producing lightweight concrete ready mix. In general, during the subsequent curing process, the pellet size remains unchanged. Thus, the pan pelletizer 80 can be used to control the grade or size of material in a number of ways.

After agglomerating but prior to sizing, the green pellets are cured. A variety of conventional techniques may be used for curing. For operation of the process on a continuous flow through basis, a bin or preferably a carbon dioxide curing drum 84 is used. The curing step comprises two steps: exposing the green pellets to carbon dioxide and cooling slowly the pellets in a curing room. After agglomerating, green pellets are exposed to carbon dioxide for about 5-10 minutes in a rotating drum for the purpose of speeding up the hydration process. This process involves an exothermic reaction that releases heat from the pellets. Cooling the pellets too rapidly will slow down the curing process and consequently result in a longer waiting period before the lightweight aggregate can be sold. Consequently, a cooling off step occurs next.

After exposing the pellets to carbon dioxide 28, the pellets are conveyed to a curing room and stacked on the floor for about a minimum 6 hours to slowly cool. If the pellets are to be dropped to the floor, damage to the pellets by breakage can be reduced by interposing preferably a plurality of parallel oriented energy dissipating plates 91 disposed in the center of the curing pile 90 to deflect the pellets onto the curing pile 90. The energy dissipating plates 91 are a series of plates tipped in alternating directions. In one embodiment of the invention, the pellets drop down from the shuttle conveyor 89, land upon the top of energy dissipating plates 91, then roll back and forth down the energy dissipating plates 91 until the pellets settle at the top of the aggregate pile 90 upon the floor. Also be aware that prematurely sending the pellets to be sieved in the next sizing operation can result in undesirable breakage.

After curing, the cured pellets are sorted according to size. A variety of conventional techniques may be used for sizing the pellets. For operation of the process on a continuous flow through basis, a screen 96 such as a sieve can be used to separate the material into fine, coarse, and oversized gradations.

Conduct of the above described process on a large scale, continuous flow, industrial basis will be understood from the following descriptions taken in connection with the accompanying drawings. The description is intended to be exemplary only, and should not be understood as limiting. The process may be applied in a variety of arrangements, utilizing either continuous flow or batch processing methods. However, the details disclosed in the proposed example do indicate a particular preferred, efficient, unique and advantageous method of processing on a continuous flow through basis.

FIGS. 1A and 1B reflect a plan for conduct of a process according to the present invention on a continuous flow through basis. In FIG. 1A, the steps of rough mixing, homogeneous mixing and agglomerating are shown. In FIG. 1B, the steps of curing, cooling and product storing are illustrated.

Throughout the figures, pumps are illustrated with a standard symbol (see for example hydrogen peroxide metering pump 130 and water metering pump 130). It is understood that the pump locations may be varied, depending upon particular, specific, configurations in systems used.

Also, throughout the figures, particulate removal systems such as bag houses, precipitators and cyclonic separators are shown. It will be understood that although specific arrangements may be illustrated, for example bag houses 108 and 110 in a particular given situation, alternate arrangements may be used.

The process described in FIGS. 1A and 1B will be illustrated as conducted with a single ash element 21 from a single source but a mixture of ash materials are also contemplated within the scope of the invention. For example, in the particular process illustrated, a blend of several ash materials 21 from different power plant combustion processes could be used together as a lightweight fine material source.

Referring now to the drawings, prior to the rough mixing step, from the outside sources, the ash material 21 delivered to the plant will be pneumatically conveyed by tanker truck into the plant ash silos 32, 42. Portland cement 22 will also be delivered in tanker trucks and pneumatically conveyed to a cement silo 52. The pigment 24 is delivered to the plant by means of 4,000 lb super sacks. Super sacks of pigment 24 will be raised to the proper level by an elevator type conveyor. Super sacks then will be opened and the pigment 24 placed into the pigment silos 62.

The ash 21 flows past an open slide gate 36,46 and moves through a rotary valve 37, 47 into an impact weigher 38,48 for measuring. The ash 21 is transferred by a screw conveyor 39,49 into the first mixing screw 70 for mixing with the cement 22 and optionally with the pigment 24.

Cement 22 held in a cement silo 52 is subjected to vibrations by the cement bin discharger 54 near the bottom of the cement silo 52 to counteract clumping when exiting at the narrowed base of the cement silo 52. Cement 22 flows out the bottom of the cement silo 52 past the cement slide gate 56 and through a cement rotary valve 57 for measuring by cement impact weigher 58. The cement 22 is conveyed from the cement impact weigher 58 to the first mixing screw 70 by means of a cement screw conveyor 59.

For making lightweight colored aggregate, the delivery mechanism for the pigment 24 is a pigment silo assembly 60 that includes a pigment silo 62 for receiving pigment from 4,000 pound super sack bags. The pigment 24 flows out the bottom of the pigment silo 62 past an open pigment slide gate 66 into a pigment volumetric feeder for measuring. The pigment 24 is then transported to the pigment volume 55 by a pigment screw conveyor 69 into the first mixing screw 70.

During the rough mixing, the normal and the maximum flow rates of ash into the first mixing screw 70 is about 17.3 and 21.63 tons/hour. Normal flow rate and maximum flow rate for cement into a first mixing screw 70 is about 1.73 and 2.16 tons/hour. The normal and the maximum flow rates for pigment into the first mixing screw 70 is about 0.95 and 1.18 tons/hour. The type of mixing of the ash 21 cement 22 and pigment 24 in the first mixing screw 70 is a rough or casual mixing.

After rough mixing in the first mixing screw 70, the dry material is conveyed to a paddle mixer 72. High shear mixing homogeneously mixes the mixture. Pitched paddles inside the paddle mixer moves the material from the bottom of the trough of each side and forces the material back down between the shafts. The paddle mixer 72 creates a kneading and folding-over effect that aggressively mixes together the ash 21, the cement 22 and the pigment 24. Out from the paddle mixer 72 the mixture is transported horizontally by a second mixing screw 74 and then elevated vertically by a feed elevator 76 to a screw conveyor 78 that conveys the material to the next stage of the process, agglomeration.

The paddle mixer 72 is connected at one end to the mixing screw 70 and at the other end is connected to a second mixing screw 74. The other end of the second mixing screw 74 is connected to the bottom end of a feed elevator 76. The top end of the feed elevator 76 discharges the mixture into a screw conveyor 78. The other end of the screw conveyor 78 is connected to the 16-foot pan pelletizer 80. Water 26 and hydrogen peroxide 27 are controlled by a flow meter 138 and are connected to the pan pelletizer 80. A third end of the pan pelletizer 80 is connected to an inclined belt conveyor 82.

A particulate removal system or device, such as a bag house precipitator or separator for removal of particulates is used in the mixing area. In the FIG. 1A, dusting gases are shown to arise from areas such as but not limited to the paddle mixer 72 and the feed elevator 76 and be directed into a first bag house 108 for removal of particulates. From the first bag house 108 particulates are collected and directed to the pan pelletizer 80 for agglomeration.

From a water source such as a water tap, water 26 is directed through a metering pump 130 and a flow meter 138 to a spray nozzle 132 and then onto the previously mixed material within the pan pelletizer 80. The fine mist from the water spray nozzle 132 is used to help moisten the material to form small seed type particles on the rotating pan of the pan pelletizer 80 that will eventually snow ball into larger particles until the pellets discharge from the pan pelletizer 80.

Hydrogen peroxide 27 is directed from a hydrogen peroxide tank 127 through a metering pump 130 and a flow meter 138 to a spray nozzle 132 onto the pan pelletizer 80. The hydrogen peroxide 27 is either mixed in a water tank such that all the water needed to make the lightweight aggregate will be used to dilute the hydrogen peroxide 27, or the hydrogen peroxide 27 can be fed into the waterline via a metering pump 130. The number of nozzles is a function of the radius of the pan pelletizer 80 such that all of the dry mixture is exposed to the spray in the pan pelletizer 80.

The pan pelletizer 80 is fed dry material from the paddle mixer 72 and the first bag house 108 into a rotating pan of the pan pelletizer 80. Water 26 and hydrogen peroxide 27 are sprayed in a fine mist onto the material adjacent to and subsequent to the material feeder (not shown) location on the pan pelletizer 80. The mixed material is continually added to the pan and wetted by the fine water spray to create seed particles that roll into larger particles until they are discharged from the pan pelletizer 80.

A reroll ring 152 may optionally be mounted onto the periphery of the pan pelletizer 80 for applying calcium stearate 25 to the pellets. The reroll ring 152 is fixed to the exterior of the pan pelletizer 80 such that the snowballing pellets cascade down from the sloped pan pelletizer 80 into the calcium stearate 25 stored on the reroll ring 152 for coating the pellets with the calcium stearate 25. The lip of the reroll ring 152 that extends perpendicularly away from and relative to the base of the pan pelletizer 80 a distance farther than the lip of the pan pelletizer 80 stops the downward roll of the coated pellets and rotates the pellets for about one revolution of the pan before discharging those pellets from the reroll ring 152 to an inclined belt conveyor 82.

Pellets discharged from the pan pelletizer 80 or from the reroll ring 152, if coating the colored lightweight aggregate with calcium stearate 25 is desired, are first directed onto an inclined belt conveyor 82, then into a drum feed hopper 134 and then finally into a carbon dioxide curing drum 84 to begin the curing process.

For the curing stage, a carbon dioxide curing drum 84 is connected to the other end of the inclined belt conveyor 82 by way of the drum feed hopper 134. Mounted inside the body of the carbon dioxide curing drum 84 are at least four mixing flights 172 spaced 90 degrees from each other for folding the aggregate pellets to ensure uniform carbon dioxide gas 28 contact with the aggregate pellets. Also a carbon dioxide storage tank 128 is connected to the carbon dioxide curing drum 84. Another end of the carbon dioxide curing drum 84 is connected to a load-out conveyor 88 by means of a product elevator 86 and a conveyer 85. A shuttle conveyor 89 is disposed below the load-out conveyor 88. A curing pile 90 of pellets, preferably contained in the form of a curing bay comprising three walls, is accumulates below the shuttle conveyor 89. The curing pile 90 is moved to the surge hopper 136 by front end loader and dumped onto the screen feed conveyor 94 for sorting by a screen 96 disposed below the screen feed conveyor 94.

In a preferred embodiment of the invention the curing pile 90 comprises a plurality of curing piles 90 each pile 90 being retained by a storage bin such as three or more walls below the shuttle conveyor 89.

In the first step of the curing process, the green uncured pellets are exposed to carbon dioxide 28 inside the rotating carbon dioxide curing drum 84 for about 5-10 minutes. The curing drum 84 rotates slowly and is positioned to create a slight incline of less than 10 degrees relative to the floor. The pellets exit the carbon dioxide curing drum 84 into the conveyor 85 and are elevated by product elevator 86 to a stationary load-out conveyer 88. Then the pellets are transferred from the load-out conveyer 88 onto a shuttle conveyer 89 to a curing pile 90 on the floor of a curing room. If the means used for conveying the pellets to the curing pile 90 involves dropping the pellets onto the floor, damage to the pellets by breakage can be reduced by interposing preferably a plurality of parallel oriented, energy dissipating plates 91 mounted to legs and disposed in the center of the curing pile 90, each plate being positioned at about 45 degrees relative to the floor, to break the fall of the pellets and to deflect the pellets onto the curing pile 90. The pellets drop down from the shuttle conveyor 89, land upon the top of energy dissipating plates 91, then down the energy dissipating plates 91 until the pellets settle at the top of the aggregate pile 90 upon the curing room floor.

During the second step of the curing process, the pellets on the curing pile 90 cool slowly for about 6 to 8 hours. A human operator can use a front-end loader to transport the cured pellets to a surge hopper 136 that then directs the pellets onto a screen feed conveyer 94 to drop the pellets onto a vibrating screen 96 for sizing. Water drained from the curing pile 90 is diverted away from the curing pile 90 to a water treatment device 92.

For sizing the aggregate, an oversized product belt 102 is disposed beneath the screen 96 and above a coarse product belt 104. The third belt, the fine product belt 106 is disposed below the coarse product belt 104 and the screen 96. Fine pellets drop through the screen 96 onto a fine product belt 106 that transfers the pellets out to a storage pile. Coarse grade pellets exiting the screen 96 fall onto a coarse product belt 104 and are transferred to a coarse product pile for sale. The remaining oversized pellets having a diameter greater than the coarse grade pellets after contacting the screen 96 are directed to an oversized product belt 102 for conveyance to a crusher and are then conveyed onto the fine product pile.

In the sizing area, a second bag house 110 collects particulate matter and directs it to the fine product belt 106 for filing in the fine product area. Thus the raw materials go through first, a mixing stage, second, an agglomerating stage, third, a curing stage, and then, a sizing stage to produce colored and noncolored lightweight aggregate of various gradations for sale.

Several additional optional embodiments of the present invention involve the introduction of calcium stearate 25 into the lightweight aggregate for reducing the absorption of the lightweight aggregate product. The process for producing colored lightweight aggregate in the step of homogeneously mixing a pigment with the raw material mixture from the step of mixing comprises homogeneously mixing calcium stearate 25 with the pigment with the raw material mixture as shown in FIG. 1A above the paddle mixer 72. In the process for producing colored lightweight aggregate after the step of agglomerating the material mixture, calcium stearate 25 is add to the colored lightweight aggregate.

In this preferred embodiment, a reroll ring 152 is attached to the outside diameter of the pan pelletizer 80. As the lightweight aggregate spills out of the pan pelletizer 80, the lightweight aggregate lands in the reroll ring 152 where the calcium stearate 25 can be added by rolling the lightweight aggregate in the calcium stearate 25 on the reroll ring 152 thereby coating the exterior of the lightweight aggregate pellet.

In the process for producing colored lightweight aggregate during the step of curing the agglomeration, add calcium stearate 25 to the colored lightweight aggregate. In the process for producing lightweight aggregate the step of mixing a raw material mixture including cement 22 and a lightweight fine material includes calcium stearate 25 in the raw material mixture. In the process for producing lightweight aggregate, further comprising after the step of agglomerating the material mixture, add calcium stearate 25 to the lightweight aggregate. In the process for producing lightweight aggregate during the step of curing the mixture, add calcium stearate 25 to the lightweight aggregate. In another preferred embodiment, the calcium stearate 25 is introduced to the lightweight aggregate at the upstream end of the carbon dioxide curing drum 84.

The following description will indicate how a facility designed generally according to the description given above with respect to FIGS. 1A and 1B can be operated to produce lightweight aggregate according to the present invention. The information provided is exemplary only. That is, it provides an indication of how the process can be conducted, in a preferred and efficient manner, and provides a basis for understanding the invention generally.

Assume a system in which lightweight aggregate is to be produced at a dry weight of about 40,000 pounds (20 tons) per hour. The aggregate will be generally characterized below.

For example of such a process, the following raw material could be used: The source of the coal combustion fly ash could be fourfold: Xcel Energy Co. (XCEL fly ash), Becker, Minn. and Minnesota Power Co. (MP fly ash), Cohasset, Minn., Pulliam fly ash (from Pulliam Power Co., Green Bay, Wis.) and Kraft fly ash (from Kraft Paper Co., Green Bay, Wis.). The feed with respect to them is as follows: Becker XCEL fly ash—8,350 pounds per hour (dry); MP fly ash—8,350 pounds per hour (dry); Pulliam fly ash—8,350 pounds per hour (dry); Kraft fly ash—8,350 pounds per hour (dry).

TABLE I
Normal tons/hour
Normal Flow Rates (tons/hour)

| Material | 141 | 142 | 143 | 144 | 145 | 146 | 147 | 148 | 149 |
|---|---|---|---|---|---|---|---|---|---|
| Ash | 17.3 | 0 | 0 | 17.3 | | | 17.3 | | 17.3 |
| Cement | 0 | 1.73 | 0 | 1.73 | | | 1.73 | | 1.73 |
| Pigment | 0 | 0 | 0.95 | 0.95 | | | 0.95 | | 0.95 |
| H202 | | | | | 0.17 | 0 | 0.17 | | 0.17 |
| Water | | | | | 0 | 3.8 | 3.8 | | 3.8 |
| CO2 | | | | | | | | 0.13 | 0.13 |
| Calcium | | | | 0.02 | | | 0.02 | | 0.02 |
| Stearate | | | | | | | | | |
| Total | 17.3 | 1.73 | 0.95 | 20.0 | 0.17 | 3.8 | 23.97 | 0.13 | 24.10 |

TABLE II
Maximum tons/hour
Maximum Flow Rates (tons/hour)

| Material | 141 | 142 | 143 | 144 | 145 | 146 | 147 | 148 | 149 |
|---|---|---|---|---|---|---|---|---|---|
| Ash | 21.63 | 0 | 0 | 21.63 | | | 21.63 | | 21.63 |
| Cement | 0 | 2.16 | 0 | 2.16 | | | 2.16 | | 2.16 |
| Pigment | 0 | 0 | 1.18 | 1.18 | | | 1.18 | | 1.18 |
| H2O2 | | | | | 0.19 | 0 | 0.19 | | 0.19 |
| Water | | | | | 0 | 4.75 | 4.75 | | 4.75 |
| CO2 | | | | | | | | 0.15 | 0.15 |
| Calcium | | | | 0.03 | | | | | 0.03 |
| Stearate | | | | | | | | | |
| Total | 21.63 | 2.16 | 1.18 | 25 | 0.19 | 4.75 | 30.39 | 0.10 | 30.09 |

There are several ways to change the size of the pellets from a predetermined coarse to fine grade by controlling the pan pelletizer 80. First, adjust the pan angle of the pelletizer 80 within the 40-60 degree range such that the steeper the angle of the pan, the finer the pellets. Secondly, adjust the speed of the pan's rotation such that the faster the rotation, the finer the pellets. Third, change the feed location going into the pan of the pelletizer 80. Fourth, adjust the spray whereby the finer the spray, the finer the aggregate. Finally, to change the grade of the pellets, the location of the spray can be adjusted.

One ton of the product was produced in a pilot plant operation. The raw materials used to form the lightweight aggregate product were as described above in the hypothetical example for a continuous plant operation. The relative amounts of the components were the same as described, as well. The loose bulk density of the lightweight aggregate was 65 pounds per cubic foot (pcf).

The lightweight aggregate product can be used to produce a lightweight concrete mix such as lightweight concrete ready mix. This is advantageous because there will be less weight for a given volume of concrete mix; the dead load in structures formed from the concrete will be less, and the placement of the concrete will generally be easier for workers and for larger loads of concrete mix. For example, the weight of a shipping package or container of concrete can be reduced from about 144 pounds to about 97 pounds per cubic foot by using lightweight aggregate according to the present invention.

In general, the lightweight aggregate replaces the rock aggregate (gravel) and sand in the concrete formulation. The other ingredients of the concrete formulation will be conventional ingredients such as water and cement mix.

A typical concrete mix formulation uses about 60% by weight rock aggregate (gravel). Because the ash aggregate of the present invention is lighter than the gravel and the sand, a lower percent of the concrete mix will be needed to make the lightweight aggregate, typically about 15% to 30%.

Despite the lower percent of the concrete mix, the strength of concrete made from lightweight aggregate is comparable to the strength of concrete made from gravel aggregate. However, concrete mixes made with lightweight aggregate according to the present invention will generally absorb more water during setting than concrete made from gravel aggregate. This propensity should be accommodated in the formulation of mix/water in preparing the concrete. Generally, formulations in which all of the rock aggregate has been replaced with lightweight aggregate according to the present invention will absorb about 12-14% more water by weight. Thus, when the lightweight concrete mix is prepared for pouring with water, about 12-14% more water by weight will be used than in a conventional mix.

A lightweight concrete mix using lightweight aggregate as described above was prepared according to the following formulation, the percent being given by weight:

Fine lightweight aggregate 60%

Coarse lightweight aggregate 40%

Type I cement (conventional Portland cement): amount is computed by the following:

The sum of the fine lightweight aggregate weight added to the coarse lightweight aggregate weight is divided by about 5 to determine the amount of cement weight to use. Fine lightweight aggregate passes through a ⅜th inch, #8 sieve. The coarse lightweight aggregate is retained by a ⅜th inch, #8 sieve.

Other uses for the colored and noncolored lightweight aggregate include but are not limited to asphalt pavement, geotechnical, horticulture, and specialty applications. Asphalt pavement (rural, city & freeway) uses include surface treatments, plant mix seal overlay, open-graded friction coarse, hot mix surface coarse, micro surfacing (slurry seal), and cold mix (pothole patch, minor repairs, etc.). Geotechnical uses include fill over poor soil & marshlands, insulating backfill & insulating road base, shallow foundations, enveloping underground conduits & pipelines for insulation or when in unstable soil conditions, and in landfill leachate drainage systems. Horticulture uses include soil conditioner (planting, golf greens, potting soil, etc.), soil conditioner for dirt tracks (running, bike, horse, stock car), baseball infields, ground cover (decorative and insulating), herbicide and fertilizer carrier, and hydroponics. Specialty uses include topping on wood floor systems, roof fill for flat roofs (insulation and slope), insulating fill around temperature sensitive elements, bagged concrete, and mix. Other miscellaneous uses include grog for clay brick, coverstone and ballast on built-up roofs, de-slicking/traction grit for icy roads, medium in wastewater treatment and water filters, and fire protection for impermeable plastic liners. This lightweight aggregate can also be used as a hollow core fill for producing space within precast or prestressed concrete panels during its manufacture.

Previously in the detailed description the process for making colored lightweight aggregate has been described as pigment 24 in a pigment silo 62 that is conveyed into a first mixing screw 74 rough mixing with the cement 22 and ash 21. In this alternative embodiment, the pigment silo 62 directs pigment 24 directly into the paddle mixer 72 and pigment 24 is omitted from the entire rough mixing stage.

The dry lightweight fine material continuous process for noncolored lightweight aggregate is similar to the previously described colored lightweight aggregate process except with one modification. Because the pigment 24 is not used in this noncolored process, the use of a paddle mixer 72 is omitted. The ash 21 and cement 22 mixture after rough mixing in the first mixing screw 70 is directed to the pelletizer 80 for the agglomerating stage. Consequently, the homogeneous mixing step is omitted here.

The wet lightweight fine material continuous process for colored lightweight aggregate process requires the same special handling as the following wet lightweight fine material process describes for a noncolored lightweight aggregate. Additionally, since pigment is involved here, the additional homogeneous step is included here and utilizes a paddle mixer 72.

A wet lightweight fine material in a continuous process for making noncolored lightweight aggregate differs in the following ways from the previously described lightweight aggregate process using dry lightweight fine material. The first step is excavating the ash from power plant wet scrubber reclamation ponds. The second step is draining the water from the wet scrubber ash in stock piles. The third step is mixing the ash blend with cement and hydrated lime. The mixture includes in proportion 12 pounds of wet scrubber ash, 6 pounds of bottom ash, 0.015 pounds of fly ash, four pounds of Portland cement and two pounds of hydrated lime.

The fourth step is the agglomerating step by pelletizing. This pelletizing step comprises four substeps: feeding the mixture into a rotating pan, exposing the mixture to an ultraviolet light source, spraying a fine mist of hydrogen peroxide onto the mixture in the pan pelletizer 80, and spraying water onto the mixture to make pellets. An example of the ultraviolet light source in addition to sunlight that could be used in the exposing second step could be a small fluorescent light source of 18 inches length, with a low amount of watts such as a grow lamp, for a brief duration of a second or more. Although unnecessary, higher wattage and longer exposure time are acceptable for this process. The amount of hydrogen peroxide sprayed onto the mixture can be 0.28 pounds at a concentration of 17.5% hydrogen peroxide.

The fifth stage, curing the pellets, comprises two substeps: exposing the green pellets to carbon dioxide in a rotating drum for 24 hours and cooling off slowly the pellets in a curing room. The sixth step is sizing the pellets into fine, coarse and over size gradations and is the same as the previously described sizing step.

The purpose for adding calcium stearate 25 to the lightweight aggregate mixture is to reduce moisture absorption by the finished lightweight aggregate. The calcium stearate 25 is added as a dry powder at a rate of 1 pound per 100 pounds of Portland Cement, or 1.73 pounds per dry ton of mixture at the paddle mixer 72. The calcium stearate 25 is thoroughly mixed together with the ash 21 and the cement 22 (and with the pigment 24 when used).

Another preferred method of utilizing the calcium stearate 25 more efficiently to produce a better lightweight aggregate pellet is by coating the lightweight aggregate pellets as they come off of the pan pelletizer 80. A reroll ring 152 is attached to the outside diameter of the pan pelletizer 80. As the lightweight aggregate spills out of the pan pelletizer 80, the lightweight aggregate lands in the reroll ring where the calcium stearate can be added by rolling the lightweight aggregate in the calcium stearate on the reroll ring thereby coating the exterior of the lightweight aggregate pellet.

Still another preferred method of utilizing the calcium stearate 25 in the production of lightweight aggregate pellet is by feeding the calcium stearate 25 to the pellets at the upstream end of the carbon dioxide curing drum 84. As the carbon dioxide curing drum 84 rotates, the aggregate pellets roll within the drum in the calcium stearate 25 thereby coating the aggregate pellets with the calcium stearate 25.

A dry lightweight fine material used in a batch process for making colored lightweight differs from the continuous process previously described as follows. The first step is mixing 10 pounds of fly ash, 2.26 pounds of Portland cement and pigment together. If a dark color is desired, 0.62 pounds of pigment is added to the mixture. If a lighter shade of lightweight aggregate is desired, less pigment is used, such as approximately 0.30 pounds of pigment. The mixture is then dumped into a rotating pan pelletizer 80. The second step of agglomerating by pelletizing is similar to previous steps and comprises: feeding the mixture into the rotating pan, exposing the mixture to ultraviolet light source for approximately one minute, and spraying the fine mist of hydrogen peroxide onto the upper right quadrant of the clockwise rotating pan pelletizer where the mixture material is being fed onto the pan. Additional water in the form of a mist as also added to the same quadrant to create pellets.

After the pellets are discharged from the pan pelletizer 80, they are placed in a stationary barrel with the free end of a gas hose inserted therein. Carbon dioxide 28 from a carbon dioxide bottle (not shown) is slowly bled into the barrel through the pellets to provide the first stage of curing. The pellets are left in the barrel overnight and in the morning are removed and typically placed for cooling on a floor that is covered with a sheet of plywood. The purpose for exposing the pellets to carbon dioxide 28 is to speed up the hydration process. An exothermic reaction releases heat from the pellets. Cooling the pellets too rapidly will slow down the curing process and result in a longer waiting period before the lightweight aggregate can be sold.

The process of making a wet lightweight fine material in batch for colored lightweight aggregate is similar to the process for making dry lightweight fine material in batch for colored lightweight aggregate. However, there is a mixing of the ash blend with cement and hydrated lime. The mixture includes in proportion 12 pounds of wet scrubber ash, 6 pounds of bottom ash, 0.015 pounds of fly ash, four pounds of Portland cement and two pounds of hydrated lime.

The invention provides for the first time colored lightweight aggregate.

Both wet and dry lightweight fine material continuous processes for making noncolored lightweight aggregate have been improved by the present invention. The curing step has been improved in at least four ways. The splitting step has been eliminated. A second improvement to the curing step is a significant savings in time spent exposing the pellets to carbon dioxide 28. The previous 12-24 hour period has now been reduced to an exposure period to carbon dioxide 28 of between 5 and 10 minutes. A third curing step improvement is the reduction in time spent cooling off in a curing room from previously a 12-24 hour holding period to now a 8 hour period. A fourth improvement to the curing step is the elimination of the step needed for breaking-up clumps by using a rotating drum during the carbon dioxide exposing step.

The mixing step has been improved also. The problem of clumping up during the mixing stage has been eliminated. Now both the previously separate steps of introducing hydrogen peroxide into the raw material mixture and the introducing of the water spray into the mixture steps have been combined into one step but with the same functions retained. Also, coarse and fine lightweight aggregates can be made into various gradations and can be sold at each grade.

In addition to the numerous improvements to the noncolored process for making lightweight aggregate, new processes for making colored lightweight aggregate is provided. The colored lightweight aggregate process provides a lightweight aggregate that is uniformly colored throughout the lightweight aggregate. Consequently, when a concrete product made from the colored lightweight aggregate is split or burnished, the interior colored portion of the lightweight aggregate is exposed within the concrete product interior and provides an aesthetically pleasing combination of shades and colors. The noncolored lightweight aggregate has a pewter color. The colored lightweight aggregate to date has been made in blue, green, yellow, black, red, and red-brown.

Another important advantage of the present invention is the many other uses for the colored and noncolored lightweight aggregate that include but are not limited to asphalt pavement, geotechnical, horticulture, specialty, and other miscellaneous uses previously described.

A significant advantage to producing colored lightweight aggregates is that they can be used to make a lightweight concrete mix that is uniformly the same color both on the outside as well the inside. Color combinations can be used to provide an array of aesthetically pleasing products. Colored lightweight aggregate produced from the processes of this invention can be used to make colored lightweight concrete in most any desired color and in different shades of any individual color.

A benefit to the environment and to society of the present invention is that it can, if desired, be conducted with about 90 percent waste products and about ten percent additives. That is, the advantageous commercial product can be prepared utilizing mostly waste products with few additives. As a result, it can be used to reduce landfills and economically handle disposition of waste materials to advantage. For example, just one plant operating under the process of the present invention can use about 100,000 tons of ash per year. It is noted that the process provides a fused material from which undesirable components do not readily leach. For example, fly ash may occasionally include arsenic. While such a material may be leachable from the ash itself, it is not leachable as readily from the resulting aggregate.

The invention provides both colored and noncolored lightweight aggregate with reduced moisture permeability.

The present invention having thus been described, other modifications, alterations, or substitutions may now suggest themselves to those skilled in the art, all of which are within the spirit and scope of the present invention. It is therefore intended that the present invention be limited only by the scope of the attached claims below.

What is claimed is:

1. A process for producing a colored lightweight aggregate, comprising the steps of:
(a) mixing a raw material mixture including cement and a lightweight fine material;
(b) homogeneously mixing a pigment with the raw material mixture from said step of mixing (a);
(c) agglomerating the material mixture from said step of homogeneously mixing (b); and
(d) curing the agglomeration from said step of agglomerating (c) in the presence of carbon dioxide to produce the colored lightweight aggregate.

2. A process for producing lightweight aggregate, comprising the steps of:
(a) mixing a raw material mixture including cement and a lightweight fine material;
(b) agglomerating said mixture from said step of mixing (a);
(c) during said step of agglomerating (b), adding hydrogen peroxide and water to the mixture from said step of agglomerating (b); and
(d) curing the mixture from said step of adding hydrogen peroxide (c) for producing the lightweight aggregate from the lightweight fine material without a kiln.

3. The process for producing lightweight aggregate as recited in claim 2, wherein the step of curing in presence of carbon dioxide (d) occurs in a rotating container for enhancing aggregate exposure to carbon dioxide and for deterring the aggregate from clumping up into chunks.

4. The process for producing colored lightweight aggregate as defined by claim 1, wherein the lightweight fine material comprises scrubber ash and hydrated lime.

5. The process for producing colored lightweight aggregate as defined by claim 4, wherein the lightweight fine material comprises fly ash.

6. The process for producing colored lightweight aggregate as defined by claim 5, wherein the lightweight fine material comprises bottom ash.

7. The process for producing lightweight aggregate as defined by claim 2, wherein the lightweight fine material comprises scrubber ash and hydrated lime.

8. The process for producing lightweight aggregate as defined by claim 7, wherein the lightweight fine material comprises fly ash.

9. The process for producing lightweight aggregate as defined by claim 8, wherein the lightweight fine material comprises bottom ash.

10. The process for producing lightweight aggregate as defined by claim 3, wherein the lightweight fine material comprises scrubber ash and hydrated lime.

11. The process for producing lightweight aggregate as defined by claim 10, wherein the lightweight fine material comprises fly ash.

12. The process for producing lightweight aggregate as defined by claim 11, wherein the lightweight fine material comprises bottom ash.

13. A concrete mix comprising:
(a) cement; and
(b) a lightweight aggregate produced by the process of claim 1.

14. A concrete mix according to claim 4, wherein
(a) said lightweight fine material comprises ash.

15. A concrete mix comprising:
(a) cement; and
(b) a lightweight aggregate produced by the process of claim 2.

16. An apparatus for making colored lightweight aggregate, comprising:
(a) a mixer for mixing raw material of a lightweight fine material, cement, and pigment;
(b) an agglomerator for agglomerating the raw mixture, said agglomerator being connected to the mixer; and
(c) a carbon dioxide curer connected to the agglomerator for curing the agglomeration in the presence of carbon dioxide for making colored lightweight aggregate from a lightweight fine material without a kiln.

17. An apparatus for making colored lightweight aggregate, comprising:
(a) a rough mixer for casually mixing raw materials including cement and a lightweight fine material;
(b) a homogeneous mixer connected to the rough mixer for homogeneously mixing the raw materials with a pigment;
(c) an agglomerator connected to the homogeneous mixer for agglomerating a mixture from said homogeneous mixer;
(d) a sprayer connected to a hydrogen peroxide source, said sprayer being in liquid communication with the mixture from said homogeneous mixer in the agglomerator; and
(e) a carbon dioxide curer connected to the agglomerator for curing the agglomeration in the presence of carbon dioxide for making lightweight aggregate from the lightweight fine material without a kiln.

18. An apparatus for making lightweight aggregate from a lightweight fine material, comprising:
(a) a mixer for mixing cement and a lightweight fine material;
(b) an agglomerator connected to said mixer for agglomerating the raw material mixture;
(c) and a carbon dioxide curer connected to the agglomerator, said curer including a rotating container for curing the agglomeration in the presence of carbon dioxide to enhance aggregate exposure to carbon dioxide and to deter the aggregate from clumping up into chunks for making lightweight aggregate from the lightweight fine material without a kiln.

19. A colored lightweight aggregate comprising:
(a) a cement element;
(b) a lightweight fine material;
(c) a pigment element;
(d) said cement element, said ash element and said pigment element being agglomerated together and cured in the presence of carbon dioxide to produce the lightweight aggregate; and
(e) said lightweight aggregate having color.

20. A colored lightweight aggregate according to claim 19, wherein the color comprises blue.

21. A colored lightweight aggregate according to claim 19, wherein the color comprises yellow.

22. A colored lightweight aggregate according to claim 19, wherein the color comprises green.

23. A colored lightweight aggregate according to claim 19, wherein the color comprises black.

24. A colored lightweight aggregate according to claim 19, wherein the color comprises red.

25. A colored lightweight aggregate according to claim 19, wherein the color comprises red-brown.

26. The process for producing colored lightweight aggregate as recited in claim 1, wherein said lightweight fine material is ash.

27. The process for producing lightweight aggregate as recited in claim 3, wherein said lightweight fine material is ash.

28. The apparatus for producing colored lightweight aggregate as recited in claim 16, wherein said lightweight fine material is ash.

29. The apparatus for producing colored lightweight aggregate as recited in claim 17, wherein said lightweight fine material is ash.

30. The apparatus for producing lightweight aggregate as recited in claim 18, wherein said lightweight fine material is ash.

31. The process for producing colored lightweight aggregate as defined by claim 1, wherein said step of (b) homogeneously mixing a pigment with the raw material mixture from said step of mixing (a) comprises homogeneously mixing calcium stearate with the pigment and the raw material mixture.

32. The process for producing colored lightweight aggregate as defined by claim 1, wherein after said step of agglomerating the material mixture (c), adding calcium stearate to the colored lightweight aggregate.

33. The process for producing colored lightweight aggregate as defined by claim 1, wherein during said step of curing the agglomeration (d), adding calcium stearate to the colored lightweight aggregate.

34. The process for producing lightweight aggregate as defined by claim 2, wherein said step of mixing a raw material mixture including cement and a lightweight fine material (a) includes calcium stearate in the raw material mixture.

35. The process for producing lightweight aggregate as defined by claim 2, further comprising after said step of agglomerating the material mixture (c), adding calcium stearate to the lightweight aggregate.

36. The process for producing lightweight aggregate as defined by claim 2, wherein during said step of curing the mixture (d), adding calcium stearate to the lightweight aggregate.

37. The process for producing lightweight aggregate as defined by claim 3, wherein said step of mixing a raw material mixture including cement and a lightweight fine material (a) includes calcium stearate in the raw material mixture.

38. The process for producing lightweight aggregate as defined by claim 3, further comprising after said step of agglomerating the material mixture (c), adding calcium stearate to the lightweight aggregate.

39. The process for producing lightweight aggregate as defined by claim 3, wherein during said step of curing the mixture (d), adding calcium stearate to the lightweight aggregate.

40. A concrete mix according to claim 13, further comprising calcium stearate.

41. A colored lightweight aggregate according to claim 19, further comprising calcium stearate.

42. The apparatus for making colored lightweight aggregate according to claim 16, further comprising a reroll ring connected to the agglomerator for coating the colored lightweight aggregate with calcium stearate.

43. The apparatus for making colored lightweight aggregate according to claim 16, further comprising a supply source of calcium stearate in communication with the carbon dioxide curer for coating the colored lightweight aggregate with calcium stearate.

44. The apparatus for making colored lightweight aggregate according to claim 17, further comprising a reroll ring connected to the agglomerator for coating the colored lightweight aggregate with calcium stearate.

45. The apparatus for making colored lightweight aggregate according to claim 17, further comprising a supply source of calcium stearate in communication with the carbon dioxide curer for coating the colored lightweight aggregate with calcium stearate.

46. The apparatus for making lightweight aggregate according to claim 18, further comprising a reroll ring connected to the agglomerator for coating the lightweight aggregate with calcium stearate.

47. The apparatus for making lightweight aggregate according to claim 18, further comprising a supply source of calcium stearate in communication with the carbon dioxide curer for coating the lightweight aggregate with calcium stearate.
